(19) United States
(12) Patent Application Publication
(10) Pub. No.: US 2026/0349650 A1
(43) Pub. Date: Nov. 5, 2026

(54) Systems and Methods for Controlling Electronic Device Output

(71) Applicant: APPLE INC., Cupertino, CA (US)

(72) Inventor: Matthew D. Fortier, San Jose, CA (US)

(21) Appl. No.: 19/658,483

(22) Filed: Apr. 25, 2026

Related U.S. Application Data
(60) Provisional application No. 63/797,733, filed on Apr. 30, 2025.

(51) Int. Cl. G06F 3/16; G06F 1/3231; G06F 3/01

(52) U.S. Cl. CPC G06F 3/165; G06F 1/3231; G06F 3/011

(57) ABSTRACT

A presentation system generates an output according to one or more first operation parameters. The one or more first operation parameters may be determined based on a first operation power budget. An event trigger is detected using sensor data captured using one or more sensors. A second operation power budget may be determined based on the event trigger. The output is changed by updating the one or more first operation parameters to one or more second operation parameters in response to the event trigger. The one or more second operation parameters may be determined based on the second operation power budget.

### CROSS-REFERENCE TO RELATED APPLICATIONS

This application claims the benefit of United States Provisional Application No. 63/797,733, filed on Apr. 30, 2025, the content of which is hereby incorporated by reference herein for all purposes.

### FIELD

Aspects of the present disclosure relate to systems and methods for electronic device control and more particularly to controlling output by an electronic device.

### BACKGROUND

Electronic devices may execute a variety of different operations, including content generation and output. In some contexts, certain operations of an electronic device may consume more power than desired and/or affect user experience.

### SUMMARY

Implementations described and claimed herein provide systems and methods for controlling electronic device output. In some implementations, a sound system is associated with an electronic device. The sound system outputs audio according to one or more first audio parameters. The one or more first audio parameters may be determined based on a first acoustic power budget. An event trigger is detected using sensor data captured using one or more sensors. A second acoustic power budget may be determined based on the event trigger. Output of the audio is changed by updating the one or more first audio parameters to one or more second audio parameters in response to the event trigger. The one or more second audio parameters may be determined based on the second acoustic power budget.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

FIG. 1 shows a block diagram illustrating example electronic device output control.

FIG. 2 shows a block diagram of an example electronic device.

FIG. 3 shows a block diagram of an example electronic device.

FIG. 4 illustrates example operations for electronic device output control.

FIG. 5 shows a block diagram of an example computing system for electronic device output control.

### DETAILED DESCRIPTION

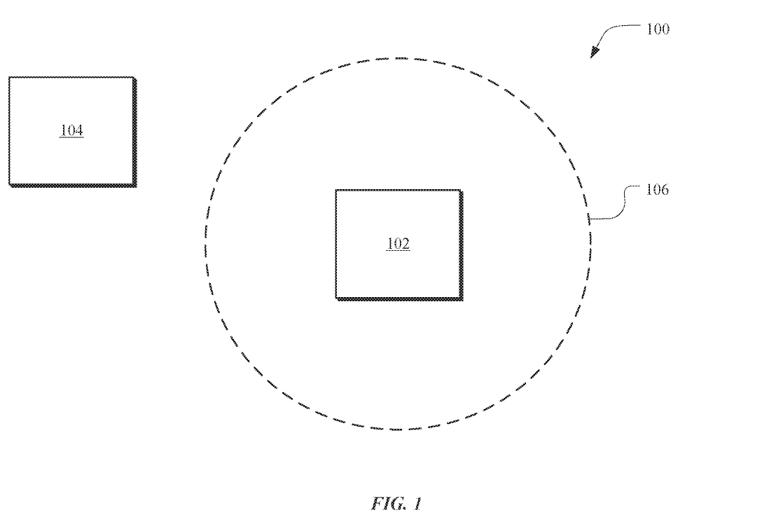

To begin a detailed description of example electronic device output control, reference is made to FIG. 1, showing an environment 100. In some implementations, an electronic device 102 in an environment 100 may receive power from one or more power sources. For example, the electronic device 102 may include one or more batteries having a power level that changes as the electronic device 102 executes one or more operations, the electronic device may receive power from an external power source, the electronic device 102 may transition between an idle mode and an active mode, and/or the like. Each of the various operations executed by the electronic device 102 leverages a portion of an overall power budget. Some operations may be allocated a larger portion of the overall power budget than other operations based on anticipated power consumption. As power is consumed during different operations according to allocations within the overall power budget, the power level of the electronic device 102 decreases. If power decreases below a power threshold, certain operations may be affected. Accordingly, to maximize operational efficiency and resource management while executing operations, the electronic device 102 may dynamically update the overall power budget according to a power allocation model, with power allocated among one or more operation power budgets based on a comparison of the power level to a power threshold of the electronic device 102, anticipated consumption of corresponding operations, priority of corresponding operations, and/or the like. Based on the power allocation model, corresponding operation(s) may be restricted and/or otherwise modified.

Additionally or alternatively, various operation(s) may be restricted and/or otherwise modified based on an interaction model of the electronic device 102 in generating a user experience for one or more users. For example, a user 104 may be within the environment 100 in which the electronic device 102 is located. The user 104 may be interacting with the electronic device 102, approaching the electronic device 102 for interaction, discontinuing interaction with the electronic device 102, intermittently interacting with the electronic device 102, and/or present within the environment 100 without interacting with the electronic device 102. The interaction model may configure the electronic device 102 to provide resources and operations for generating an interaction environment for user interaction, including capturing user input from the user 104 and/or presenting information to the user 104 (e.g., volume level of audio, display orientation, touch interaction, movement, content output, wake operations, animation, power conservation, etc.). The interaction model may consider user preferences, resource allocation (e.g., allocation of operation power budget(s), allocation of compute resources, etc.), priority level of an operation relative to other operations, environmental conditions within the environment 100, and/or other conditions associated with the user 104 and/or the electronic device 102. The interaction model of the electronic device 102 may be configured for a particular user (e.g., the user 104) according to user preferences. The electronic device 102 may include a plurality of interaction models configured for a plurality of users, such that multiple users may interact with and use the electronic device 102, with the electronic device 102 individually tailoring its operation to the specific user with which the electronic device 102 is interacting, being controlled by, and/or otherwise being used by. The various operations of the electronic device 102 may be executed according to one or more operation parameters, which may be defined based on the power allocation model and/or the interaction model.

In some implementations, the electronic device 102 is disposed in the environment 100. The environment 100 may generally correspond to an area external to the electronic device 102, which may be indoors, outdoors, or a combination thereof. In some examples, the area corresponds to a geographical region, sensible region (e.g., within detectable limit(s) of sensors of the electronic device 102), predefined region, and/or designated region (e.g., as defined by user input). The electronic device 102 may be disposed within the environment 100 in various manners and configured to execute various operations according to the one or more operation parameters.

In some implementations, the one or more operation parameters of an operation of the electronic device 102 update in real time in response to anticipated, current, and/or prior interaction with the user 104. The operations of the electronic device 102 may be configured and/or dynamically changed based on the operation parameter(s). In some examples, the electronic device 102 may be configured to move in various manners within the environment 100 based on movement parameter(s). In some examples, the electronic device 102 may be stationary with one or more moveable components and/or one or more stationary components. In other examples, the electronic device 102 may be configured to move along a movement path from a first orientation to a second orientation within the environment 100 and may include one or more moveable components and/or one or more stationary components. Each of the moveable components may be configured to move along a trajectory from a first component orientation to a second component orientation. The movement parameter(s) may include range of motion, speed of motion, rate of motion, type of motion, etc. In some examples, the electronic device 102 is configured to generate and present interaction output within the environment 100. Such interaction output may include visual output, audio output, tactile output, media, content, information, and/or so forth for user entertainment, interaction, and/or consumption. The interaction output may be generated and presented based on interaction parameter(s) (e.g., display parameter(s), acoustic parameter(s), touch parameter(s), etc.). Display parameters may include display type, display mechanism (e.g., via a screen, projection, wearable, external device, etc.), animation speed, display orientation (e.g., display based on a current position of the user 104), and/or so forth. Acoustic parameters may include sound volume, playback speed, audio mechanism (e.g., via internal speaker(s), external speaker(s), wearable, etc.), and/or so forth. Touch parameters may correspond to touch type (e.g., haptic feedback, etc.), intensity, rate, touch mechanism (e.g., via screen, internal device, external device, wearable, etc.), and/or the like. The interaction parameter(s) may also include parameters correlating the display, audio, and touch parameters with each other and other operation parameters. The operation parameters may dynamically change based on the power model, the interaction model, and/or other conditions associated with the electronic device 102, the user 104, and/or the environment 100.

For example, the electronic device 102 may detect an event trigger. The event trigger may be associated with operation of the electronic device 102, the user 104, an environmental condition of the environment 100 in which the electronic device 102 is located, and/or combinations thereof. The event trigger may correspond to user approach, interaction initiation, user departure, interaction halt, operation condition, and/or so forth. For example, the user approach may include detection of: the user moving towards the electronic device 102 (e.g., along a movement path towards the electronic device 102, a body orientation towards the electronic device 102, moving to within a proximity 106 of the electronic device 102, etc.); a hand moving towards the electronic device 102 (e.g., a hand on a movement path towards the electronic device 102, a hand positioned for touch interaction with the electronic device 102, etc.); a face of the user 104 oriented toward the electronic device 102; and/or other actions by the user 104 indicating an anticipated future interaction with the electronic device 102. The interaction initiation may include action by the user 104 initiating interaction with the electronic device 102, such as touch interaction, gaze interaction, voice interaction, receipt of user input, and/or the like. The user departure may include detection of: the user moving away from the electronic device 102 (e.g., along a movement path away from the electronic device 102, a body orientation away from the electronic device 102, exiting the proximity 106 of the electronic device 102, etc.); a hand moving away from the electronic device 102 (e.g., a hand on a movement path away from the electronic device 102, etc.); a face of the user 104 oriented away from the electronic device 102; and/or other actions by the user 104 indicating an anticipated future halting of interaction with the electronic device 102. The interaction halt may include action by the user 104 halting interaction with the electronic device 102, such as an absence of touch interaction, gaze interaction, voice interaction, receipt of user input, and/or the like within a period of time. The operation condition may correspond to power being below the power threshold, the electronic device 102 being connected to an external power source, a user preference, an environmental condition, and/or the like. The event triggers may be configured based on the interaction model, the power model, and/or otherwise based on conditions of the electronic device 102, conditions of the environment 100, and/or user preferences of the user 104.

In response to detection of the event trigger, the electronic device 102 may dynamically change the operation parameters. Stated differently, the electronic device 102 may be executing an operation according to first operation parameter(s). In response to detection of an event trigger, the electronic device 102 may identify and change the operation by updating the first operation parameter(s) to second operation parameter(s). In response to detection of a second event trigger, the operation may be changed by updating the second operation parameter(s) to the first operation parameter(s) or third operation parameter(s). In this manner, the operation may be dynamically adjusted based on event triggers. The operation parameter(s) may be determined based on the power model and/or the interaction model in some examples.

For example, audio output may be executed based on an acoustic model defined based on the power model (e.g., an acoustic power budget) and the interaction model (e.g., user preferences for audio volume, prioritization of audio interaction relative to touch and/or visual interaction, etc.). The electronic device 102 may be playing audio at a first volume and detect the user 104 approaching (e.g., moving into the proximity 106). The electronic device 102 may reduce the volume of the audio from the first volume to a second volume to minimize user exposure to a loud environment and/or to otherwise accommodate user preferences. Upon detection of the user 104 exiting the proximity 106, the electronic device 102 may resume playing the audio at the first volume. Similarly, the electronic device 102 may detect the user 104 approaching and reduce the acoustic power budget, while increasing an interaction power budget for interaction operation(s) using various subsystems (e.g., using a touchscreen, display, actuator(s), IMU, etc.). In this example, the audio may consume high power in providing high output (e.g., louder volume), such that power is diverted from the sound system to interaction operation systems (e.g., display, actuators, etc.) to prioritize the interaction experience over the sound volume. The audio output lowers from the first volume to the second volume during the touch interaction and resumes at the first volume once the touch interaction halts (e.g., after touch input is not received within a time period). Using the increased interaction budget, the electronic device 102 may move moveable components to facilitate input and presentation associated with interaction (e.g., orient a touchscreen towards a face to display content and/or hand of the user 104 to facilitate receipt of touch input) and/or otherwise enhance the interaction (e.g., touchscreen brightness, animation speed, stiffen moveable components to counteract the force of touch interaction, etc.). The electronic device 102 may determine whether to adjust the sound parameters based on a comparison of a current power level to the power threshold and/or based on whether the electronic device 102 is receiving power from an external power source in some examples. As such, the electronic device 102 may consume resources, including power, and execute various operations dynamically with operational efficiency and to enhance user experience.

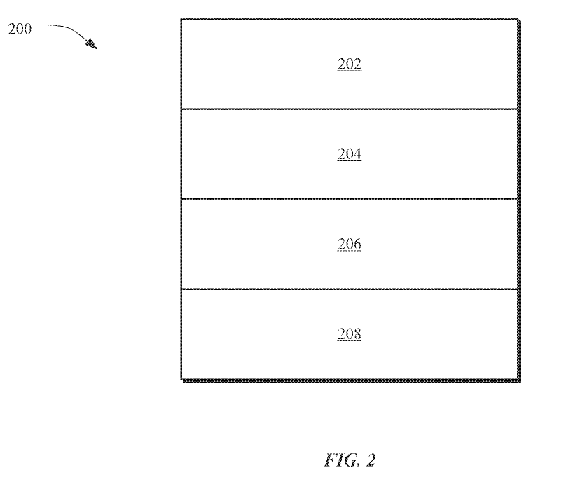

Turning to FIG. 2, an electronic device 200, which may be an example of the electronic device 102, is shown. In some implementations, the electronic device 200 includes an input system 202, a presentation system 204, one or more power sources 206, and one or more actuators 208. The input system 202 may be configured to capture various forms of user input and input data from various input sources. The input system 202 may convert a human-generated signal, such as a human voice, biometrics, physical movement, physical touch, and so forth, into electrical signals as input data. For example, the input system 202 may be configured to capture input data in the form of visual input (e.g., information provided via gesture, facial expression, gaze, body language, etc.), audio input (e.g., information provided via voice, sound, etc.), and/or tactile input (e.g., information provided via touch, such as via a touch-sensitive display screen (“touchscreen”) and/or sensor, etc.). The input system 202 may further be configured to capture input data in the form of device input (e.g., information provided via one or more input devices). The input sources of the input system 202 may include user devices (e.g., smartphones, wearables, personal computers, and/or etc.), home connected devices, cloud-based connected devices, alphanumeric input device devices (e.g., keyboard), direction and selection control devices (e.g., mouse, trackball, cursory direction key, joystick, wheel, and/or etc.), a touchscreen, and/or sensors. The sensors may be configured to capture sensor data corresponding to the electronic device 102, the user 104 according to user preferences, and/or the environment 100. For example, the sensors may generate a constellation field of view, such as a depth sensor constellation. The sensors may provide near field sensing to detect users in near field (e.g., within the proximity 106, approaching, exiting, etc.). The sensors may include depth sensor(s), image sensor(s), ambient light sensor(s) (ALS), near-field sensor(s), proximity sensor(s), sound sensor(s), encoder(s), inertial measurement unit(s) (IMU), location sensor(s), orientation sensor(s), gravitational sensor(s), inertial sensor(s), and/or accelerometer(s), and/or etc.

The presentation system 204 may be configured to generate and present content in various forms. The presentation system 204 may convert electrical signals of the electronic device 200 into signals that may be sensed as output by a user, such as sound, light, touch, and/or so forth. For example, the presentation system 204 may present content in the form of visual, audio output, haptic output, and/or tactile output. In some examples, the presentation system 204 includes various moveable components, which can generate output in the form of movement using the one or more actuators 208. The presentation system 204 may include one or more output devices, such as a display, a touch screen, projector, light source, speaker, moveable components (e.g., using the one or more actuators 208, etc.), and/or so forth. In some examples, the input system 202 and/or the presentation system 204 include one or more environment transducer devices that convert one form of energy or signal into another for input into or output from the electronic device 200. For example, an electrical signal generated within the electronic device 200 may be converted to another type of signal, and/or vice-versa. In some instances, the environment transducer devices sense characteristics or aspects of the environment 100 local to and/or remote from the electronic device 200. Further, the environment transducer devices may generate signals to impose some effect on the environment in which the electronic device 200 is located. The input system 202, the presentation system 204, and the one or more actuators 208 may provide an interactive experience for the user through the capture of input data, presentation of content and other output data, and/or movement by the electronic device 200 and/or moveable component(s). The input system 202 and the presentation system 204 may include various software and/or hardware for input and presentation. The input system 202 and the presentation system 204 may be integrated into one system, in whole or part, or separate. For example, the input system 202 and the presentation system 204 may be provided in the form of a touchscreen. Further, the input system 202, the presentation system 204, and the one or more actuators 208 may be integrated into, in whole or part, or separate, in whole or part, from the electronic device 200.

The electronic device 200 may execute operations based on one or more operation parameters and dynamically change the operation parameters. The electronic device 200 may change the operation parameters in response to an event trigger in some examples. The operation parameter(s) may be determined based on a power model associated with an overall power budget of the one or more power sources 206 and operation power budgets associated with corresponding operations of the electronic device 200. The one or more power sources 206 may have a power threshold below which there is insufficient power to execute one or more operations of the electronic device 200. Accordingly, the electronic device 200 may reallocate power among operation power budgets associated with the input system 202, the presentation system 204, the one or more actuators 208, and/or in association with other operations of the electronic device 200. For example, operations of the electronic device 200 may be restricted, prioritized, halted, and/or otherwise modified based on a comparison of a current power level of the one or more power sources 206 with the power threshold of the one or more power sources 206. The reallocation may be eliminated or modified when the electronic device 200 is receiving power from an external power source in some examples. Additionally or alternatively, the operation parameter(s) may be determined based on an interaction model associated with generating a user experience for one or more users. For example, various operations of the input system 202, the presentation system 204, and/or the one or more actuators 208 may be executed by the electronic device 200 according to movement parameter(s), interaction parameter(s), and/or so forth. In this manner, each operation may have its own operation power budget (e.g., an acoustic power budget of the presentation system 204 for outputting audio) that is configured and dynamically adjusted based on operation parameter(s) that may be defined based on a power model of the one or more power sources 206, event triggers, an interaction model of the electronic device 200, and/or so forth. Further, each operation may contribute to a user experience that is generated and dynamically adjusted based on the operation parameters. The electronic device 200 may dynamically adjust the operation parameter(s) for various operations to budget power and provide a user experience in accordance with user preferences.

In some examples, the electronic device 200 may be battery-powered with the one or more power sources 206 including one or more batteries. The presentation system 204 may include a sound system having one or more speakers configured to output audio. The speakers may be positioned at various locations on the electronic device 200. The electronic device 200 may include one or more moveable components that are configured to move along a trajectory from a first component orientation to a second component orientation using the one or more actuators 208. The one or more actuators 208 may be associated with one or more motor(s) (e.g., direct drive motors that are back-drivable) to move the moveable component(s). In some examples, at least a portion of the input system 202 and/or the presentation system 204 move using the one or more actuators 208. The input system 202 and the presentation system 204 may include a touchscreen that the one or more actuators 208 rotate and/or otherwise move to change a position and/or orientation of the touchscreen relative to one or more references, such as a base of the electronic device 200, an axis of the electronic device 200 (e.g., a longitudinal axis), and/or a user (e.g., a face of a user). Other portions of the input system 202 and/or the presentation system 204, such as speakers, may similarly rotate and/or otherwise move relative to one or more references, including to generate directional audio output. In some examples, the presentation system 204 may be playing audio using the speakers. One or more of the sensor(s), such as near-field, ALS sensors, and/or so forth, may detect a user approaching the electronic device 200. The electronic device 200 may reduce a volume of the audio, pause the audio, and/or otherwise automatically modify the audio output in response to the user approaching the electronic device 200. The electronic device 200 may automatically adjust a visual output (e.g., via a screen of the presentation system 204, etc.), such as a light brightness (e.g., to match a detected surrounding light level in the environment of the electronic device 200, etc.). Other modifications to output by the presentation system 204 in response to an approaching user are contemplated.

The modification to output by the presentation system 204 (e.g., reduction in audio volume, etc.) may be based on a reallocation of power budget. The reallocation of power budget may preserve power for and/or otherwise reallocate power to the one or more actuators 208 to move the electronic device 200 and/or moveable components of the electronic device 200 in response to the approaching user. For example, the one or more actuators 208 may move a touchscreen of the input system 202 and the presentation system 204 towards the user into an interaction orientation to facilitate interaction (e.g., towards a face of the user, towards a hand of the user, etc.). The one or more actuators 208 may further actuate to maintain the touchscreen in the interaction orientation during interaction. For example, the one or more actuators 208 may be associated with back-drivable motors and/or certain moveable components may have a flexible connection, such that an application of force by the user during interaction may move the moveable components to an orientation hindering interaction (e.g., the touchscreen may move to an orientation at least partially facing away from the user). The one or more actuators 208 may actively restrict movement of moveable components to maintain the moveable components (e.g., the touchscreen) in the interaction orientation. In some instances, the power used to move the moveable components into the interaction orientation and to maintain the interaction orientation is obtained based on the reallocation of the power budget (e.g., from the speakers of the presentation system 204 to the one or more actuators 208). The reallocation of power budget may be based on an overall power budget for the one or more power sources 206 and/or a comparison of a current power level to a threshold power level of one or more batteries of the one or more power sources 206. In some examples, the electronic device 200 may forgo reallocation of the power budget if the one or more batteries are receiving sufficient power from an external power source and/or if the current power level is above the threshold power level, such that the one or more power sources 206 can power current and/or planned operations of the electronic device 200.

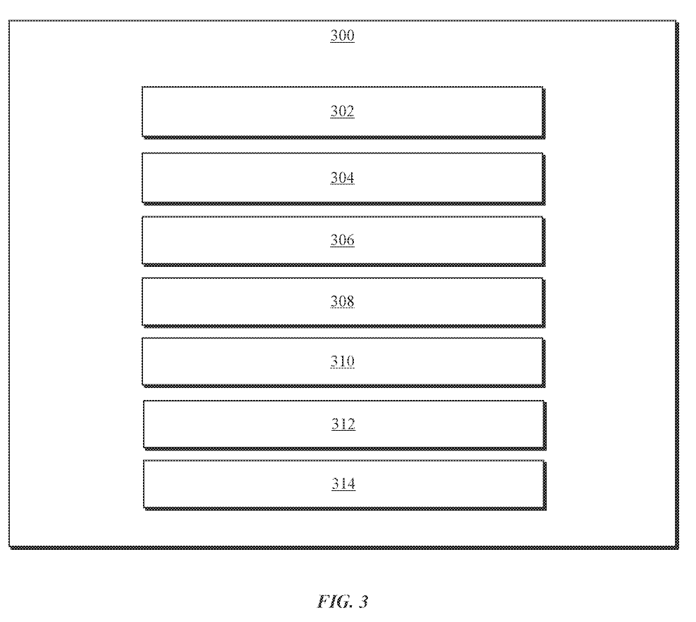

Referring to FIG. 3, an example electronic device 300, which may be an example of the electronic device 102, the electronic device 200, and/or other electronic devices, is shown. In some implementations, the electronic device 300 includes device systems. It will be appreciated that any of a sensor system 302, a perception system 304, a planning system 306, a control system 308, subsystems 310, an interface system 312, and/or a communication system 314 may be part of or separate from the device systems. The subsystems 310 may include systems corresponding to moveable and/or stationary components, and/or other systems executing operation(s) of the electronic device 300.

The sensor system 302 includes one or more sensors configured to capture sensor data, including, but not limited to: input data; perception data; data of a field of view of the electronic device 300 and/or one or more of the subsystems 310; localization data corresponding to a location, heading, and/or orientation of the electronic device 300 and/or one or more of the subsystems 310; movement data corresponding to motion of the electronic device 300 and/or one or more of the subsystems 310; and/or data corresponding to an environment in which the electronic device 300 is located. The one or more sensors of the sensor system 302 may include, without limitation, three-dimensional (3D) sensors configured to capture 3D data, two-dimensional (2D) sensors configured to capture 2D data, light detection and ranging (LiDAR) sensors, fast LiDAR sensors, radar sensors, infrared (IR) sensors, optical sensors, visual detection and ranging (ViDAR) sensors, ultraviolet (UV) sensors, microphones, ultrasonic sensors, infrasonic sensors, IMUs, encoders, pressure sensors, temperature sensors, proximity sensors, ALS sensors, near-field sensors, and/or so forth. For example, the one or more 3D sensors may include depth sensors configured to capture depth maps, point cloud data and/or other 3D data, and the one or more 2D sensors may include cameras (e.g., RGB cameras) configured to capture color images, grayscale images, and/or other 2D images. The sensor system 302 may include a localization system configured to capture localization and/or movement data. The localization systems may include, without limitation, a Global Navigation Satellite System (GNSS), inertial navigation system (INS), IMU, global positioning system (GPS), altitude and heading reference system (AHRS), compass, and/or accelerometer. The sensor system 302 may include other sensors to capture input data.

The perception system 304 may obtain perception data generated based on the sensor data and/or input data. The perception data may correspond to a user approaching the electronic device 300, a user moving in the environment in which the electronic device 300 is located, a user moving away from the electronic device 300, a user within or outside of a proximity of the electronic device 300, other stationary and/or moving objects within the environment, and/or so forth. The perception data may be used by the planning system 306 in generating one or more actions for the electronic device 300, such as generating and/or rendering content, presenting content, generating a movement plan having at least one movement action for moving the electronic device 300 and/or one or more of the subsystems 310 along a movement path from a first orientation and/or position to a second orientation and/or position, detecting a user approaching the electronic device 300, detecting a user moving away from the electronic device 300, a user initiating interaction with the electronic device 300, a user ceasing interaction with the electronic device 300, and/or to otherwise understand object(s) within the environment in which the electronic device 300 is located and/or a relationship between the electronic device 300 and such object(s). The perception data may be used to identify an event trigger.

The control system 308 may be used to control various operations of the electronic device 300 according to operational settings, including, but not limited to, generating an interactive experience, generating and presenting content, moving the electronic device 300, moving one or more of the subsystems 310, interacting within an environment, interacting with a user, and/or other operations. Motion plans for moving the electronic device 300 and/or one or more of the subsystems 310 and/or performing other operations using the subsystems 310 and/or interface system 312 may include various instructions to execute to perform corresponding operations. In some examples, the electronic device 300 moves and acts on its own planning and decisions. Instructions for operating the electronic device 300 may be executed by the planning system 306, the control system 308, the subsystems 310, and/or other components of the electronic device 300. The instructions may be modified prior to execution by the electronic device 300 (e.g., using the interface system 312 and/or input from a user device in communication with the electronic device 300 via the communication system 314), and in some cases, the electronic device 300 may disregard the instructions according to its own planning and decisions, for example, based on the sensor data captured by the sensor system 302 and/or operational settings of the electronic device 300. The control system 308 may control the operation(s) of the electronic device 300 based on event trigger(s). In some examples, the control system 308 may control operation(s) of the electronic device 300 based on a power model and/or an interaction model.

In some implementations, the interface system 312 includes an input system and a presentation system, which may be similar to the input system 202 and the presentation system 204, respectively. In some implementations, the interface system 312 provides an interactive interface. The interactive interface may be deployed on, remote from, and/or in a proximity of the electronic device 300. In some examples, the interface system 312 may be used to control and/or interact with the electronic device 300 and/or the environment in which the electronic device 300 is located. The interactive interface may be dynamically tailored through operational settings based on the relationship between the electronic device 300 and the environment and, in some examples, the power model and/or the interaction model.

The communication system 314 may include, without limitation, one or more antennae, receivers, transponders, transceivers, and/or communication ports to communicate over one or more networks and/or connections. Examples of such networks or connections include, without limitation, Universal Serial Bus (USB), Ethernet, Wi-Fi, Bluetooth®, Near-Field Communication (NFC), cellular, and so on. The communication system 314 may be utilized to communicate with one or more other machines, either directly over a point-to-point communication path, over a wide area network (WAN) (e.g., the Internet), over a local area network (LAN), over a cellular network (e.g., third generation (3G), fourth generation (4G) network, fifth generation (5G), etc.), and/or over another communication means. In some cases, the communication system 314 includes different hardware and/or software for communicating using different communication protocols and/or via different types of networks and/or connections. In some examples, the communication system 314 is configured for long-range communication (e.g., via cellular network, satellite network, radio, etc.), short-range communication (e.g., Bluetooth®, Wi-Fi, ultra-wideband, etc.) and/or to otherwise communicate with various computing devices via wired and/or wireless connections.

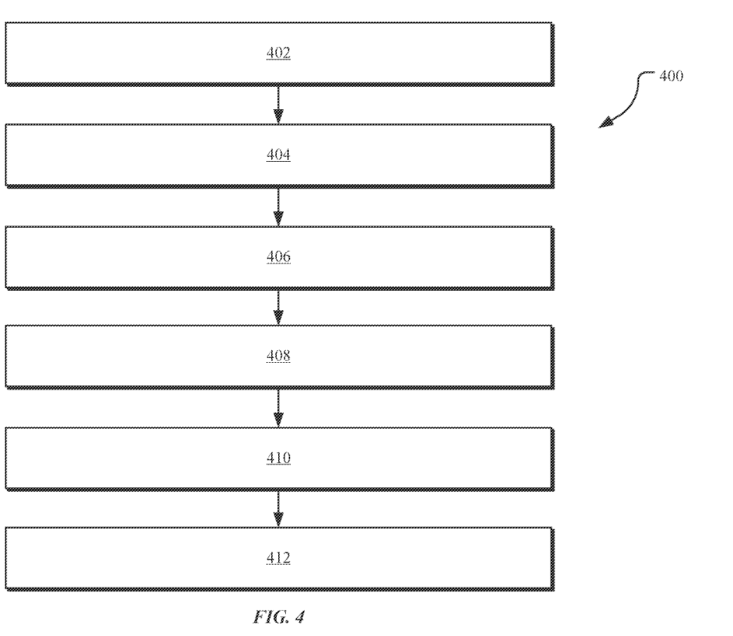

Turning to FIG. 4, example operations 400 for electronic device output control are illustrated. In some implementations, an operation 402 generates an output according to one or more first operation parameters. The output may be presented to an environment in which the electronic device is located. An operation 404 detects a first event trigger. An operation 406 determines one or more second operation parameters associated with the first event trigger. The one or more second operation parameters may be determined based on a power model associated with one or more power sources of the electronic device and/or an interaction model associated with interaction of a user with the electronic device. An operation 408 dynamically changes the output by updating the one or more first operation parameters to the one or more second operation parameters in response to the first event trigger.

An operation 410 detects a second event trigger. The first event trigger and/or the second event trigger may be associated with operation of the electronic device, the user, an environmental condition of an environment in which the electronic device is located, and/or combinations thereof. The first event trigger and/or the second event trigger may correspond to user approach, interaction initiation, user departure, interaction halt, operation condition, and/or so forth. An operation 412 dynamically changes the output by updating the one or more second operation parameters to the one or more first operation parameters in response to the second event trigger.

In some examples, the output may include audio, with the one or more first operation parameters including a first volume and the one or more second operation parameters including a second volume. The first event trigger may include detection of a user approaching the electronic device, such that the output of the audio is changed from the first volume to the second volume in response to the detection of the user approaching the electronic device. The second event trigger may include detection of the user halting interaction with the electronic device, such that the output of the audio is changed from the second volume to the first volume in response to the detection of the user halting interaction with the electronic device. The second volume may be lower than the first volume.

In some examples, at least one moveable component of the electronic device may be moved in response to the detection of the user approaching the electronic device. For example, a touchscreen may be moved into an interaction orientation, such as towards a person when the person approaches the electronic device. The electronic device may detect a person approaching the electronic device and identify the person as a known user. For example, the electronic device may identify a person as a known user based on biometrics (e.g., face, fingerprint, voice, gait, etc.), based on detection of a user device (e.g., wearable, smartphone, etc.) associated with the known user, using a user profile associated with the known user, and/or so forth. The electronic device may determine whether orienting the touchscreen towards the known user during approach is a stored preference of the known user and move the touchscreen into a corresponding interaction orientation accordingly. Stated differently, in some examples, the electronic device may move the touchscreen into a particular interaction orientation based on stored preferences associated with an identified user based on an identification of the user as the identified user approaches the electronic device. The stored preferences may be updated by users. In one implementation, orienting the touchscreen towards the person in response to the detection of the person approaching the electronic device includes moving the touchscreen based on an estimated trajectory of at least a portion of a hand of the person.

The touchscreen may be maintained in the interaction orientation during interaction (e.g., receipt of user input from the user). Power may be reallocated from an acoustic power budget to an actuator power budget in response to the detection of the user approaching the electronic device. The output of the audio being changed from the first volume to the second volume may be based on the reallocating of power. Reallocating power may be based on the electronic device receiving power from an external power source, a power level of one or more power sources of the electronic device being below a threshold power level, and/or so forth. In response to detection of the user halting the interaction with the electronic device, the power may be reallocated from the actuator power budget to the acoustic power budget, with the output of the audio changing from the second volume to the first volume. In some examples, a visual output of the touchscreen may be similarly changed from a first brightness to a second brightness in response to a first event trigger and a second event trigger. The visual output may be changed in connection with moving the touchscreen to the interaction orientation. Other examples will be appreciated from the present disclosure.

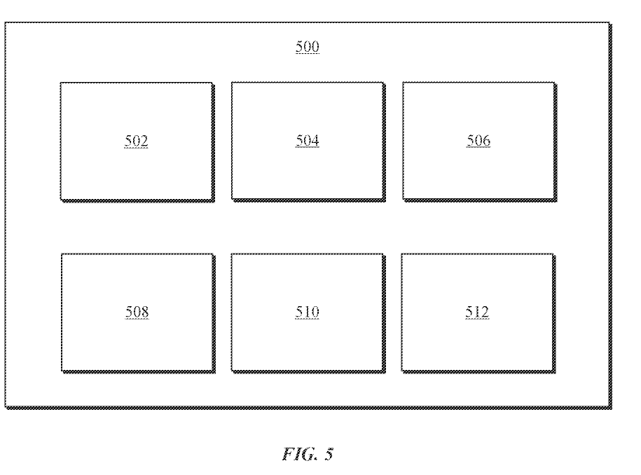

Referring to FIG. 5, a detailed description of an example computing device 500 having one or more computing units that may implement various systems and methods discussed herein is provided. The system set forth in FIG. 5 is but one possible example of a computer system that may employ or be configured in accordance with aspects of the present disclosure. It will be appreciated that other non-transitory tangible computer-readable storage media storing computer-executable instructions for implementing the presently disclosed technology on a computing system may be utilized.

Various components of the computing device 500 can be formed into a specific, non-conventional, and non-generic arrangement to achieve the various systems and methods discussed herein. As such, the computing device 500 and/or components of the computing device 500 may be applicable to the electronic device 102, the electronic device 200, the electronic device 300, various systems of the electronic device 102, the electronic device 200, and/or the electronic device 300, and/or other computing or network devices. In some examples, the electronic devices are robots, machines, security systems, home systems, vehicles, drones, interactive devices, entertainment devices, user devices, and/or so forth. It will be appreciated that specific implementations of these devices may be of differing possible specific computing architectures, not all of which are specifically discussed herein, but will be understood by those of ordinary skill.

The computing device 500 may be a computing system configured to execute a computer program product to perform a computer process. In some examples, data and program files may be input to the computing device 500, which reads the files and executes the programs. The computing device 500 may include one or more hardware processors 502, memory (e.g., one or more data storage devices 504, one or more memory devices 506, etc.), one or more ports (e.g., ports 508-512), and/or other elements that will be recognized by those skilled in the art.

The computing device 500 may be a conventional computing system, a distributed computing system, or any other type of computing system, such as one or more external computers made available via a cloud computing architecture. The technology described herein is optionally implemented in software stored in memory (e.g., on the one or more data storage devices 504, stored on the one or more memory devices 506, etc.) and/or communicated via one or more of the ports 508-512, thereby transforming the computing device 500 in FIG. 5 to a special-purpose machine for implementing the operations described herein. In some examples, the computing device 500 includes purpose-built autonomy processors, actuators, components, and/or so forth.

In some examples, the one or more hardware processors 502 may include a central processing unit (CPU), a microprocessor, a microcontroller, a digital signal processor (DSP), and/or one or more internal levels of cache. The one or more hardware processors 502 may comprise a single central-processing unit, or a plurality of processing units capable of executing instructions and performing operations in parallel with each other, commonly referred to as a parallel processing environment.

The one or more data storage devices 504 may include a non-volatile data storage device capable of storing data within the computing device 500, such as computer-executable instructions for performing a computer process, which may include instructions of both application programs and an operating system (OS) that controls various elements of the computing device 500. Examples of the one or more data storage devices 504 include flash drives, solid-state drives, magnetic disk drives, optical disk drives, and/or so forth. The one or more data storage devices 504 may include removable data storage media (e.g., DVDs, CDs, etc.), non-removable data storage media (e.g., magnetic drives, SSDs, etc.), and/or external storage devices made available via wired or wireless networks. The one or more memory devices 506 may include volatile memory (e.g., SRAM, DRAM, etc.) and/or non-volatile memory (e.g., ROM, flash memory, etc.).

Computer program products containing instructions to effectuate the systems and methods in accordance with the technology described herein may reside in memory, such as the one or more data storage devices 504 and/or the one or more memory devices 506. Such memory may be referred to as machine-readable media. It will be appreciated that machine-readable media may include any non-transitory tangible computer-readable storage media that is capable of storing or encoding instructions to perform any one or more of the operations described herein for execution by a machine or that is capable of storing or encoding data structures and/or modules utilized by or associated with such instructions. Machine-readable media may include a single medium or multiple media (e.g., a centralized or distributed database, associated caches and servers, and/or etc.) that store the one or more executable instructions or data structures.

The described disclosure may be provided as a computer program product, or software, that may include one or more non-transitory tangible computer-readable storage media having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). Implementations described herein are illustrative, and the scope of the present disclosure is not limited to them.

Various elements of the computing device 500 may communicate with one another by way of one or more communication buses, point-to-point communication paths, and/or other communication means. The computing device 500 may include one or more port(s), such as an input/output port 508, a communication port 510, a subsystems port 512, and/or so forth, for communicating with other computing, network, or electronic devices. It will be appreciated that the port(s) may be combined or separate in various combinations, and that more or fewer ports may be included in the computing device 500.

In some examples, the input/output port 508 connects the computing device 500 to one or more input devices, output devices, and/or other systems configured as input data sources and/or for presentation of output data. Information is input to and/or output from the computing device 500 (e.g., to and/or from the input system and/or output system) via the input/output port 508. Such input/output devices may include one or more input devices, output devices, and/or environment transducer devices.

The input devices may convert a human-generated signal into electrical signals as input data into the computing device 500 via the input/output port 508. The output devices may convert electrical signals received from computing device 500 via the input/output port 508 into signals that may be sensed as output by a user. The input devices may communicate information and/or commands to the one or more hardware processors 502 via the input/output port 508. The output devices may receive information and/or commands from the one or more hardware processors 502 via the input/output port 508. The environment transducer devices may convert energy into a signal (or vice versa) for input into (or output from) the input/output port 508 for use by the computing device 500. The environment transducer devices sense characteristics or aspects of an environment local to or remote from the computing device 500 in some implementations. Further, the environment transducer devices may generate signals to impose some effect on the environment, either local to or remote from the example computing device 500.

In some implementations, a communication port 510 is connected to a network. Using the communication port 510, the computing device 500 may receive network data corresponding to the methods and systems described herein and/or transmit information. Stated differently, the communication port 510 connects the computing device 500 to one or more communication interface devices configured to transmit and/or receive information between the computing device 500 and other devices via one or more wired or wireless communication networks or connections. Further, the communication port 510 may communicate with an antenna for electromagnetic signal transmission, reception, and/or to receive localization data to facilitate determination of a location of the electronic device and/or its subsystems.

The computing device 500 may include the subsystems port 512 for communicating with one or more subsystem systems to operate the electronic device and/or exchange information between the computing device 500 and one or more subsystems of the electronic device. Examples of such subsystems include motor controllers and systems, power systems, environment controls, entertainment systems, controls, actuators, processors, movement systems, the subsystems 310, and/or so forth.

The operations disclosed herein may be implemented as sets of instructions or software readable by a device. The specific order or hierarchy of steps in the methods disclosed are instances of example approaches, and the specific order or hierarchy of steps in the method can be rearranged while remaining within the disclosed subject matter. The accompanying method claims present elements of the various steps in a sample order and are not necessarily meant to be limited to the specific order, combination, or hierarchy presented. Variations, modifications, additions, and/or improvements are possible and may fall within the scope of the disclosure as defined in the claims that follow.

What is claimed is:

1. An electronic device comprising:
a presentation system associated with the electronic device, the presentation system configured to generate an output according to one or more first operation parameters and to present the output to an environment in which the electronic device is located; and
one or more sensors configured to detect an event trigger, update the one or more first operation parameters to one or more second operation parameters in response to the event trigger, and change the output according to the one or more second operation parameters.

2. The electronic device of claim 1, wherein at least one of the one or more first operation parameters or the one or more second operation parameters is determined based on a power model associated with one or more power sources of the electronic device.

3. The electronic device of claim 1, wherein the presentation system includes a sound system having one or more speakers, the output including audio, the one or more first operation parameters including a first volume and the one or more second operation parameters including a second volume, the second volume being lower than the first volume.

4. The electronic device of claim 3, wherein the event trigger includes detection of a person approaching the electronic device, such that the sound system is configured to change the output of the audio from the first volume to the second volume in response to the detection of the person approaching the electronic device.

5. The electronic device of claim 4, further comprising:
one or more actuators configured to move at least one moveable component in response to the detection of the person approaching the electronic device, the one or more actuators moving the at least one moveable component in connection with the sound system changing the output of the audio from the first volume to the second volume.

6. The electronic device of claim 5, further comprising:
one or more power sources, wherein the one or more actuators moving the at least one moveable component in connection with the sound system changing the output of the audio from the first volume to the second volume includes diverting power from the sound system to the one or more actuators.

7. The electronic device of claim 6, wherein the power is diverted from the sound system to the one or more actuators in response to a power level of the one or more power sources being below a threshold power level.

8. The electronic device of claim 6, wherein the power is diverted from the sound system to the one or more actuators based on whether the electronic device is receiving power from an external power source.

9. The electronic device of claim 5, wherein the at least one moveable component includes a touchscreen, the one or more actuators orienting the touchscreen towards the person in response to the detection of the person approaching the electronic device.

10. The electronic device of claim 9, wherein orienting the touchscreen towards the person in response to the detection of the person approaching the electronic device includes maintaining the touchscreen in an interaction orientation relative to at least one of a hand or a face of the person, the interaction orientation determined based on user preferences determined based on an identification of the person.

11. The electronic device of claim 9, wherein orienting the touchscreen towards the person in response to the detection of the person approaching the electronic device includes moving the touchscreen based on an estimated trajectory of at least a portion of a hand of the person.

12. The electronic device of claim 4, wherein the sound system is configured to change the output of the audio from the second volume to the first volume in response to the detection of the person halting interaction with the electronic device.

13. One or more non-transitory tangible computer-readable storage media storing computer-executable instructions for performing a process on an electronic device, the process comprising:
generating an output according to one or more first operation parameters, the output presented to an environment in which the electronic device is located;
detecting an event trigger;
determining one or more second operation parameters associated with the event trigger; and
changing the output by updating the one or more first operation parameters to the one or more second operation parameters in response to the event trigger.

14. The one or more non-transitory tangible computer-readable storage media of claim 13, wherein the one or more second operation parameters are determined based on at least one of a power model associated with one or more power sources of the electronic device or an interaction model associated with interaction of a user with the electronic device.

15. The one or more non-transitory tangible computer-readable storage media of claim 13, wherein the output includes audio, the one or more first operation parameters including a first volume and the one or more second operation parameters including a second volume, wherein the event trigger includes detection of a person approaching the electronic device, such that the output of the audio is changed from the first volume to the second volume in response to the detection of the person approaching the electronic device.

16. The one or more non-transitory tangible computer-readable storage media of claim 15, the process further comprising:
moving at least one moveable component in response to the detection of the person approaching the electronic device.

17. The one or more non-transitory tangible computer-readable storage media of claim 16, the process further comprising:
reallocating power from an acoustic power budget to an actuator power budget in response to the detection of the person approaching the electronic device to change the output of the audio from the first volume to the second volume.

18. The one or more non-transitory tangible computer-readable storage media of claim 17, wherein reallocating power is based on at least one of the electronic device receiving power from an external power source or a power level of one or more power sources of the electronic device being below a threshold power level.

19. The one or more non-transitory tangible computer-readable storage media of claim 16, wherein moving the at least one moveable component includes orienting a touchscreen towards the person.

20. The one or more non-transitory tangible computer-readable storage media of claim 15, the process further comprising:
changing the output of the audio from the second volume to the first volume in response to detection of the person halting interaction with the electronic device.
